(19) United States
(12) Patent Application Publication
(10) Pub. No.: US 2026/0117566 A1
(43) Pub. Date: Apr. 30, 2026

(54) LOCKING DEVICE

(71) Applicant: AISIN CORPORATION, Kariya (JP)

(72) Inventors: Keisuke MATSUMOTO, Kariya-shi (JP); Atsuyuki MASUDA, Kariya-shi (JP)

(73) Assignee: AISIN CORPORATION, Kariya (JP)

(21) Appl. No.: 19/357,426

(22) Filed: Oct. 14, 2025

(30) Foreign Application Priority Data
Oct. 28, 2024 (JP) 2024-188723

(51) Int. Cl. E05B 83/40; E05B 85/04; E05B 79/20

(52) U.S. Cl. CPC E05B 83/40; E05B 85/045; E05B 79/20

(57) ABSTRACT

In a locking device according to this disclosure, a striker unit includes a base, a lever rotating between a first position when releasing locking and a second position when locking, and a biasing member biasing the lever toward the first position side, the biasing member includes a first end, a second end, and a biasing portion connecting the first end and the second end, the base includes a first circular-shaped hole into which the first end is inserted and a first circular-arc-shaped hole into which the second end is inserted, the lever includes a second circular-arc-shaped hole into which the first end is inserted and a second circular-shaped hole into which the second end is inserted, and the second circular-arc-shaped hole includes a second one side end with which the first end comes into contact when the lever is positioned at the first position.

### CROSS REFERENCE TO RELATED APPLICATIONS

This application is based on and claims priority under 35 U.S.C. § 119 to Japanese Patent Application 2024-188723, filed on October 28, 2024, the entire content of which is incorporated herein by reference.

### TECHNICAL FIELD

This disclosure generally relates to a locking device that locks a sliding door of a vehicle at a full-open position of the sliding door.

### BACKGROUND DISCUSSION

In JP2009-102862A (Reference 1), a vehicle including a vehicle body that has a door opening portion and a sliding door that opens and closes the door opening portion is described, and the vehicle body includes a striker shaft that is arranged in a vicinity of a lower rear end of the door opening portion.

In addition, the sliding door includes a door body, a lower arm that extends inward in a width direction from a vicinity of a lower front end of the door body, and a locking mechanism that is arranged at a tip portion of the lower arm.

When the sliding door is arranged at a full-open position at which the sliding door fully opens the door opening portion, the locking mechanism locks the striker shaft, and the sliding door is restrained with respect to the vehicle body at the full-open position.

However, in a case of the above-described configuration, the vehicle body requires a space for avoiding interference with the lower arm and the locking mechanism when the sliding door opens and closes the door opening portion, and there is a possibility that, in order to provide such a space, an internal space of the vehicle and a space under the vehicle floor may become narrower in the width direction.

Therefore, a configuration in which, in order to prevent the space from becoming narrower in the width direction of the vehicle, a lever that rotates in such a way as to cause the striker shaft to be positioned at a position at which the striker shaft is locked by the locking mechanism is provided and the striker shaft is provided on the lever is examined.

Due to the configuration, it becomes unnecessary for a latch of the locking mechanism to be positioned on an inward side of the vehicle at a time of locking by the locking mechanism, and a space for avoiding interference is enabled to be reduced.

However, a new problem arises in that the lever, which is released from locking, collides with a base that takes the lever in a rotatable manner and causes a collision sound to occur when the lever returns to a position before locking.

In addition, when cushioning material or the like is provided in order to suppress the collision sound, a manufacturing cost increases.

A need thus exists for a locking device, which is not susceptible to the drawback mentioned above.

### SUMMARY

A locking device according to this disclosure is a locking device that locks a sliding door of a vehicle at a full-open position of the sliding door,

the locking device includes:

a striker unit that is provided on a vehicle body side of the vehicle and includes a striker shaft; and

a latch mechanism that is provided on the sliding door side and locks the striker shaft at the full-open position,

the striker unit includes:

a base that is provided on a vehicle body side;

a lever that includes the striker shaft and is provided on the base in a rotatable manner between a first position at a time of releasing locking of the striker shaft and a second position at a time of locking of the striker shaft; and

a biasing member that biases the lever toward the first position side,

the biasing member includes:

a first end;

a second end; and

a biasing portion that connects the first end and the second end,

the base includes:

a first circular-shaped hole that receives the first end; and

a first circular-arc-shaped hole that receives the second end and in which the second end is movable in association with rotation of the lever,

the lever includes:

a second circular-arc-shaped hole that receives the first end and in which the first end is movable in association with rotation of the lever; and

a second circular-shaped hole that receives the second end, and

the second circular-arc-shaped hole includes a second one side end with which the first end comes into contact when the lever is positioned at the first position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of a vehicle in which a locking device of a first embodiment according to this disclosure is installed;

FIG. 2 is a top view for description of the locking device of the first embodiment according to this disclosure;

FIG. 3 is a partially exploded perspective view of a latch mechanism of the first embodiment according to this disclosure;

FIG. 4 is a diagram illustrating a state of a latch drive portion of the first embodiment according to this disclosure before latching;

FIG. 5 is a diagram illustrating a state of the latch drive portion of the first embodiment according to this disclosure after latching;

FIG. 6 is a top view of a striker unit of the first embodiment according to this disclosure illustrating a state before latching;

FIG. 7 is a top view of the striker unit of the first embodiment according to this disclosure illustrating a state after latching;

FIG. 8 is an exploded perspective view of the striker unit of the first embodiment according to this disclosure viewed from a direction A in FIG. 6;

FIG. 9 is a top view illustrating a base of the first embodiment according to this disclosure;

FIG. 10 is a top view illustrating a lever of the first embodiment according to this disclosure;

FIG. 11 is a diagram illustrating the striker shaft of the first embodiment according to this disclosure biasing a latch claw portion of a latch drive portion in a direction opposite to an arrow X in FIGS. 4 and 5;

FIG. 12 is a diagram for description of a problem to be solved by a locking device of a second embodiment according to this disclosure that locks a sliding door of a vehicle at a full-open position of the sliding door;

FIG. 13 is a diagram illustrating a torsion spring being a biasing member described in the first embodiment according to this disclosure;

FIG. 14 is an enlarged view of a vicinity of a first end when a lever is positioned at a first position of the locking device of the second embodiment according to this disclosure, which locks the sliding door of the vehicle at the full-open position of the sliding door; and

FIG. 15 is an enlarged view of a vicinity of a second end when the lever is positioned at the first position of the locking device of the second embodiment according to this disclosure, which locks the sliding door of the vehicle at the full-open position of the sliding door.

### DETAILED DESCRIPTION

Hereinafter, embodiments for implementing this disclosure (hereinafter, referred to as “embodiments”) will be described in detail with reference to the drawings.

Note that the same elements are designated by the same reference numbers or reference signs throughout the entire description of the embodiments.

In addition, the dimensional ratios in the drawings may be different from the actual dimensional ratios, and the drawings are only to facilitate understanding of the description and do not guarantee that the same parts are drawn with the same dimensions between drawings.

Further, in the drawings, there are some cases where reference signs are assigned only to some of parts with the same attributes existing at a plurality of sites for a visibility purpose.

### First Embodiment

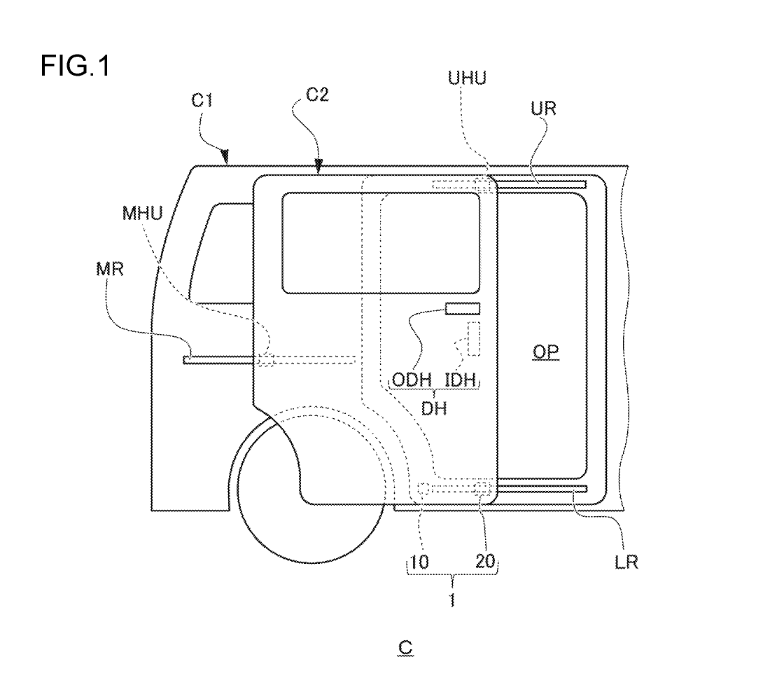

A locking device 1 of a first embodiment according to this disclosure that locks a sliding door C2 of a vehicle C at a full-open position of the sliding door C2 will be described with reference to FIGS. 1 to 11.

Note that in the following description, an advancing direction of the vehicle C, a reversing direction of the vehicle C, a horizontal direction orthogonal to a front-rear direction of the vehicle C, an upper side of the vehicle C, and a lower side of the vehicle C are referred to as a front (front side or forward direction), a rear (rear side or rearward direction), a right-left direction (right and left), an upper side, and a lower side, respectively.

Terms such as front (front side or forward direction), rear (rear side or rearward direction), right-left direction (right and left), upper side, and lower side relating to members or the like provided in the vehicle C refer to states of the members when provided in the vehicle C, unless otherwise specified.

In addition, when a left-hand side and a right-hand side in the right-left direction of the vehicle C are discriminated from each other, the left-hand side and right-hand side when the vehicle C is viewed from the rear side are referred to as the left-hand side and the right-hand side, respectively, and terms such as left-hand side and right-hand side relating to members or the like provided in the vehicle C refer to states of the members when provided in the vehicle C, unless otherwise specified.

Further, an inner side and an outer side of the vehicle C are referred to as the inner side and the outer side, respectively, and terms such as inner side and outer side relating to members or the like provided in the vehicle C refer to states of the members when provided in the vehicle C, unless otherwise specified.

FIG. 1 is a schematic diagram of the vehicle C in which a locking device 1 of the first embodiment of this disclosure is installed, and is a diagram illustrating only a portion on a rear seat side of the vehicle C.

As illustrated in FIG. 1, the vehicle C includes a vehicle body C1 and a sliding door C2 that is provided in a slidable manner on the vehicle body C1.

The vehicle body C1 includes an opening portion OP for boarding and alighting that opens when the sliding door C2 is slid to the full-open position side (the left-hand side of the drawing).

In addition, the vehicle body C1 includes an upper-side rail portion UR that is provided along an edge portion on the upper side of the opening portion OP, a middle rail portion MR that is provided at a position that is a middle position in the up-down direction of the vehicle body C1 and that is located on the rear side of the opening portion OP, and a lower-side rail portion LR that is provided along an edge portion on the lower side of the opening portion OP.

On the other hand, the sliding door C2 includes an upper-side hinge unit UHU that is provided at an upper side position on the front side of the sliding door C2 and that corresponds to the upper-side rail portion and a middle hinge unit MHU that is provided at position that is a middle position in the up-down direction of the sliding door C2 and that is located on the rear side of the sliding door C2, and that corresponds to the middle rail portion MR.

In addition, the sliding door C2 includes a latch mechanism 20 in the locking device 1, which will be described later, the latch mechanism 20 being provided at a lower side position on the front side of the sliding door C2 and functioning as a lower-side hinge unit corresponding to the lower-side rail portion LR.

Further, the sliding door C2 includes a door handle DH for performing opening-closing operation of the sliding door C2, and specifically, the door handle DH includes an inner-side door handle IDH for performing the opening-closing operation of the sliding door C2 from within the vehicle and an outer-side door handle ODH for performing the opening-closing operation of the sliding door C2 from outside the vehicle.

Note that the sliding door C2 may include a door driving device or the like for driving, when the door handle DH is operated, the sliding door C2 to a full-open position and a full-close position.

For example, the door driving device may have a general configuration to drive the sliding door C2 by transmitting power of an electric motor to the sliding door C2 via a power transmission member such as a cable and a wire.

On the other hand, the vehicle body C1 includes a striker unit 10 in the locking device 1, which will be described later, the striker unit 10 being provided in the rear of the lower-side rail portion LR.

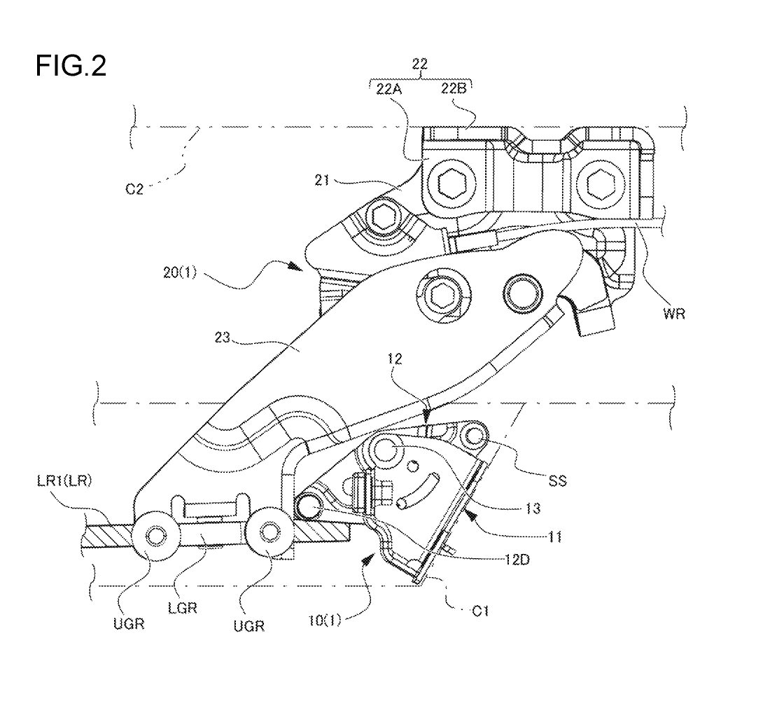

FIG. 2 is a top view for a description of the locking device 1 of the first embodiment according to this disclosure and illustrates the locking device 1 positioned on the right-hand side of the vehicle C.

Note that since a locking device positioned on the left-hand side of the vehicle C has the same configuration as that of the locking device 1 on the right-hand side of the vehicle C and an only difference is that constituent components of the right-hand side and left-hand side locking devices have horizontally symmetrical relationships, the following description will be made mainly on the locking device 1 positioned on the right-hand side of the vehicle C.

In addition, FIG. 2 illustrates a state in which the sliding door C2 has moved rearward to a position immediately before a position at which the sliding door C2 is in a fully-open state, in other words, a state immediately before the sliding door C2 is locked by the locking device 1.

Further, FIG. 2 illustrates only a rail LR1, in the lower-side rail portion LR, that guides a lower-side guide roller LGR of the latch mechanism 20.

However, the lower-side rail portion LR also has a rail that guides a pair of upper-side guide rollers UGR of the latch mechanism 20.

Specifically, a rail member (not illustrated) having the rail, in the lower-side rail portion LR, that guides the pair of upper-side guide rollers UGR of the latch mechanism 20 is provided on the vehicle body C1 in such a way as to cover the upper side of the latch mechanism 20 to form a gap allowing a portion of the latch mechanism 20 to protrude outward.

The locking device 1 of the first embodiment is a locking device 1 that locks the sliding door C2 of the vehicle C at the full-open position of the sliding door C2, and the locking device 1 includes, as illustrated in FIG. 2, the striker unit 10 that is provided on the vehicle body C1 side of the vehicle C and that has a striker shaft SS and the latch mechanism 20 that is provided on the sliding door C2 side and that locks the striker shaft SS at the full-open position.

### Latch Mechanism 20

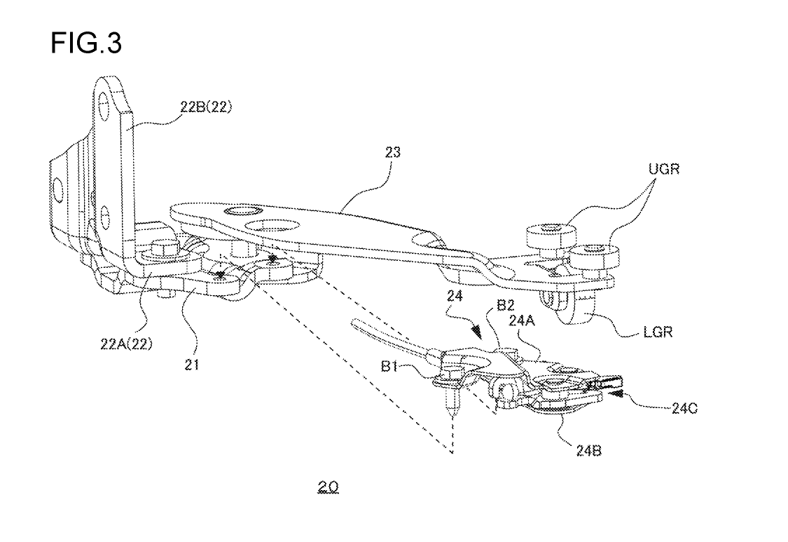

FIG. 3 is a partially exploded perspective view of the latch mechanism 20 of the first embodiment according to this disclosure.

As illustrated in FIGS. 2 and 3, the latch mechanism 20 includes a base portion 21, a mounting portion 22 in which one piece 22A is fixed to the base portion 21 and another piece 22B that rises substantially at a right angle is fixed to the sliding door C2 (see FIG. 2), and a guide portion 23 that is provided in a rotatable manner with respect to the base portion 21 and that includes guide rollers (the guide roller UGR and the pair of guide rollers UGR).

In addition, the latch mechanism 20 includes a latch portion 24 that is positioned between the base portion 21 and the guide portion 23 and that is fixed to the base portion 21.

The latch portion 24 includes, as illustrated in FIG. 3, an upper-side plate 24A, a lower-side plate 24B that is separated from the upper-side plate 24A and that forms a space between the upper-side plate 24A and the lower-side plate 24B, and a latch drive portion 24C that is provided in the space between the upper-side plate 24A and the lower-side plate 24B and that performs an operation to latch the striker shaft SS.

Note that the upper-side plate 24A is fixed to the base portion 21 with a bolt B1 and a bolt B2, and the lower-side plate 24B is co-fixed with the upper-side plate 24A to the base portion 21 at a position of the bolt B2 in such a manner as to be sandwiched between the upper-side plate 24A and the base portion 21.

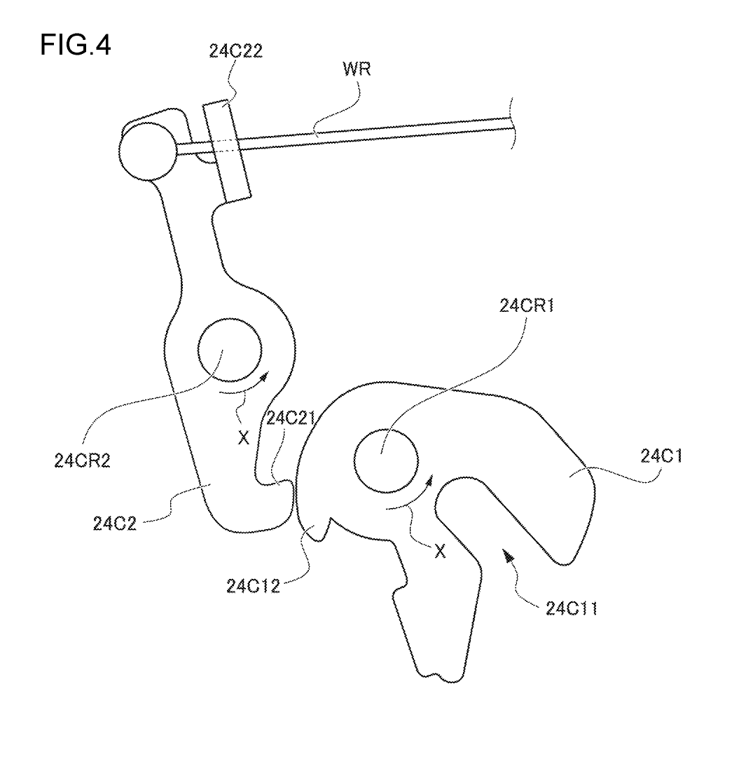

FIG. 4 is a diagram illustrating a state of the latch drive portion 24C (see FIG. 3) of the first embodiment according to this disclosure before latching.

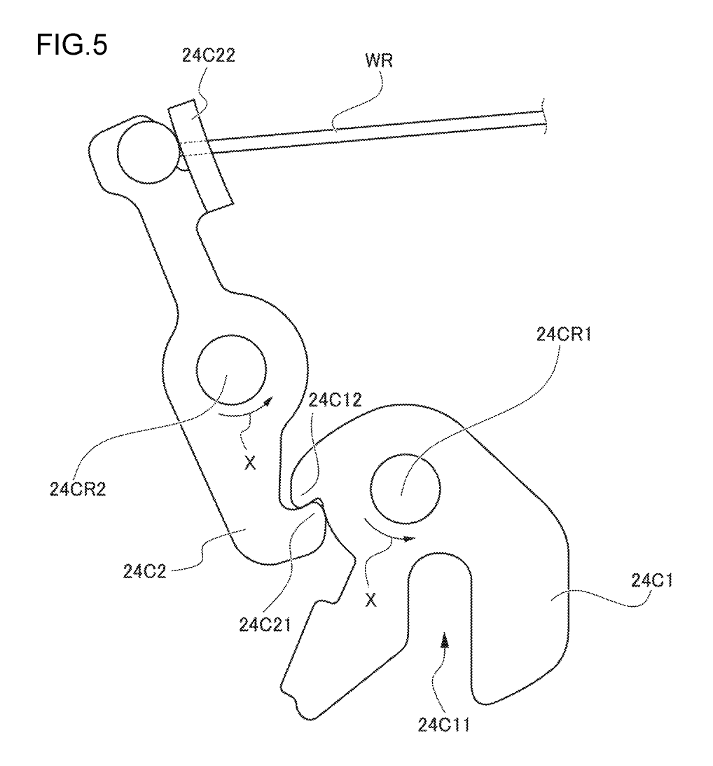

FIG. 5 is a drawing illustrating a state of the latch drive portion 24C (see FIG. 3) of the first embodiment according to this disclosure after latching.

Note that in FIGS. 4 and 5, illustration of constituent components on the striker unit 10 side is omitted.

Although by movements of the striker unit 10, which will be described later, the latch drive portion 24C is brought into a latched state, details of specific interlocking operation of the latch drive portion 24C with the striker unit 10 will be described later, and first, with reference to FIGS. 4 and 5, an overview of a configuration and operation of the latch drive portion 24C will now be described.

The latch drive portion 24C illustrated in FIG. 3 specifically includes, as illustrated in FIGS. 4 and 5, a latch claw portion 24C1 that is rotatably provided on a first shaft 24CR1 that is fixed to the upper-side plate 24A (not illustrated) and the lower-side plate 24B (not illustrated) and a lock portion 24C2 that is rotatably provided on a second shaft 24CR2 that is fixed to the upper-side plate 24A (not illustrated) and the lower-side plate 24B (not illustrated).

Note that both the latch claw portion 24C1 and the lock portion 24C2 are biased to rotate in directions illustrated by arrows X by not-illustrated torsion springs.

The latch claw portion 24C1 includes a recessed portion 24C11 that is formed as a space between a pair of claws and that receives the striker shaft SS (not illustrated) and a projecting portion 24C12 that is to be engaged with the lock portion 24C2.

On the other hand, the lock portion 24C2 includes a protrusion 24C21 that engages with the projecting portion 24C12 of the latch claw portion 24C1 and that is provided at a tip of the lock portion 24C2 and a locking portion 24C22 that is provided on the base end portion side with the second shaft 24CR2 interposed therebetween and that locks a wire WR.

Note that the wire WR is connected to the door handle DH (see FIG. 1), and when the door handle DH is operated, the wire WR is pulled toward the right-hand side of FIGS. 4 and 5.

Although described later, when the sliding door C2 is brought into a full-open state, the striker shaft SS biases the latch claw portion 24C1 in a direction opposite to the arrow X (in a clockwise direction as viewed in FIGS. 4 and 5).

When the latch claw portion 24C1 rotates to a state illustrated in FIG. 5, the protrusion 24C21 of the lock portion 24C2 engages with the projecting portion 24C12 of the latch claw portion 24C1, and this state is maintained.

In other words, by the locking device 1, a state in which the sliding door C2 of the vehicle C is locked to maintain the sliding door C2 at the full-open position is established.

On the other hand, when the door handle DH (see FIG. 1) is operated while the locking device 1 is in the state illustrated in FIG. 5, the wire WR moves toward the right-hand side of the drawing and the locking portion 24C22 is pulled to the right-hand side of the drawing.

Since as a result, the lock portion 24C2 rotates about the second shaft 24CR2 in the direction opposite to the arrow X (in the clockwise direction as viewed in FIGS. 4 and 5), the engagement between the projecting portion 24C12 of the latch claw portion 24C1 and the protrusion 24C21 of the lock portion 24C2 is released.

In other words, the locking of the sliding door C2 by the locking device 1 to maintain the sliding door C2 at the full-open position is released, and it becomes possible to close the sliding door C2.

### Striker Unit 10

Next, the striker unit 10 of the first embodiment according to this disclosure will be described.

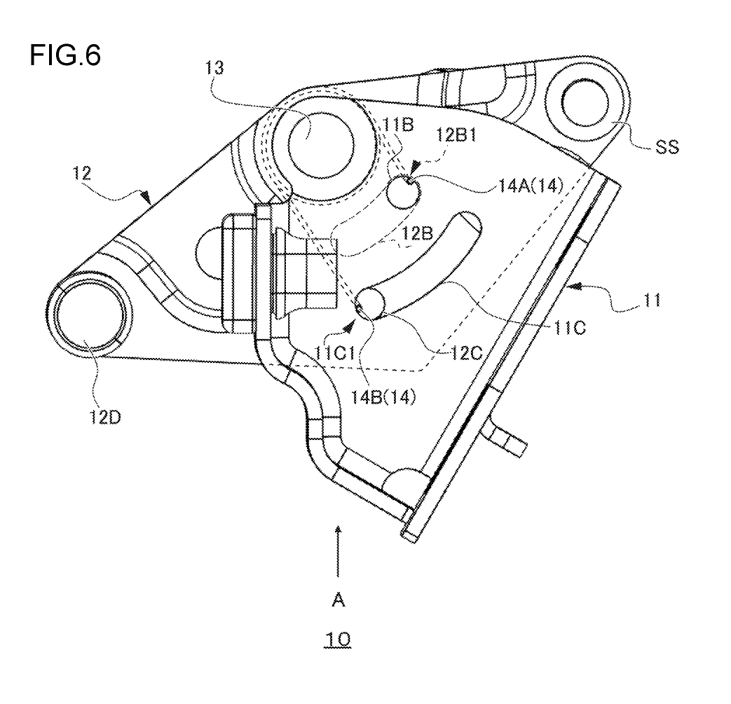

FIG. 6 is a top view of the striker unit 10 illustrating a state before latching in the first embodiment according to this disclosure.

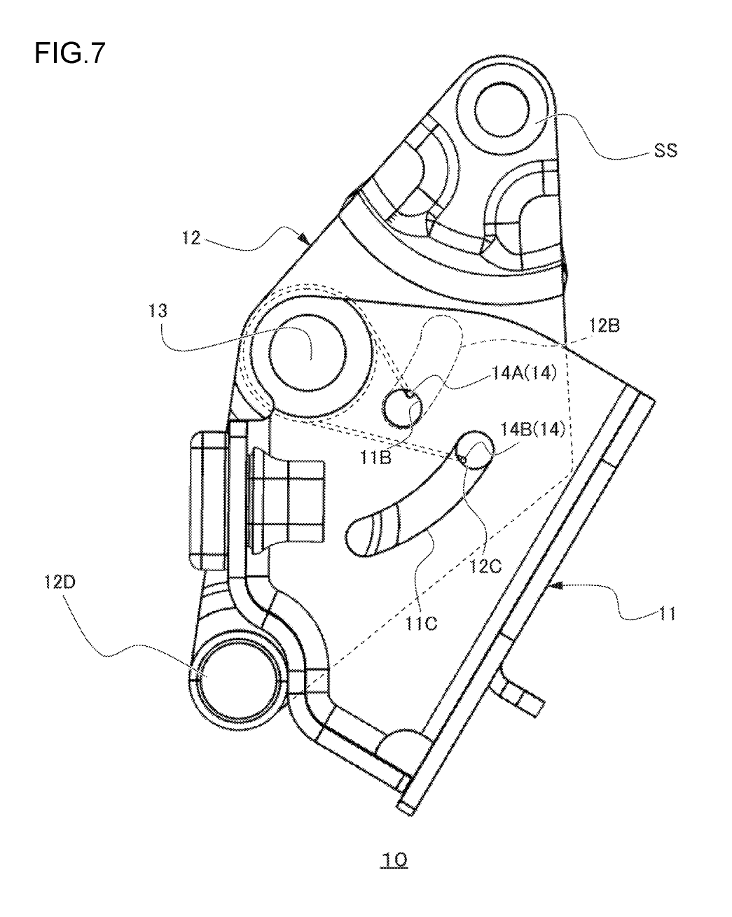

FIG. 7 is a top view of the striker unit 10 illustrating a state after latching in the first embodiment according to this disclosure.

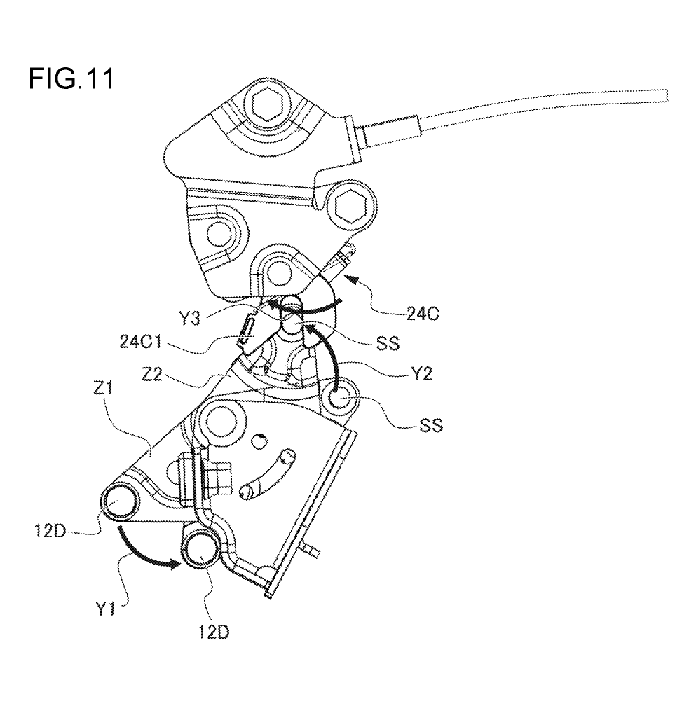

Note that in FIGS. 6 and 7, illustration of constituent components on the latch mechanism 20 side is omitted, and details of interlocking operation with the latch mechanism 20 will be described later with reference to FIG. 11.

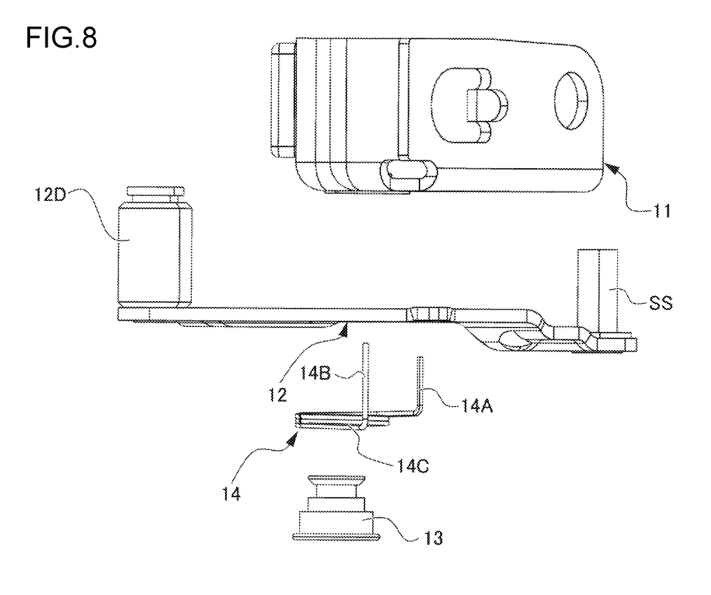

FIG. 8 is an exploded perspective view of the striker unit 10 of the first embodiment according to this disclosure viewed from the direction A in FIG. 6.

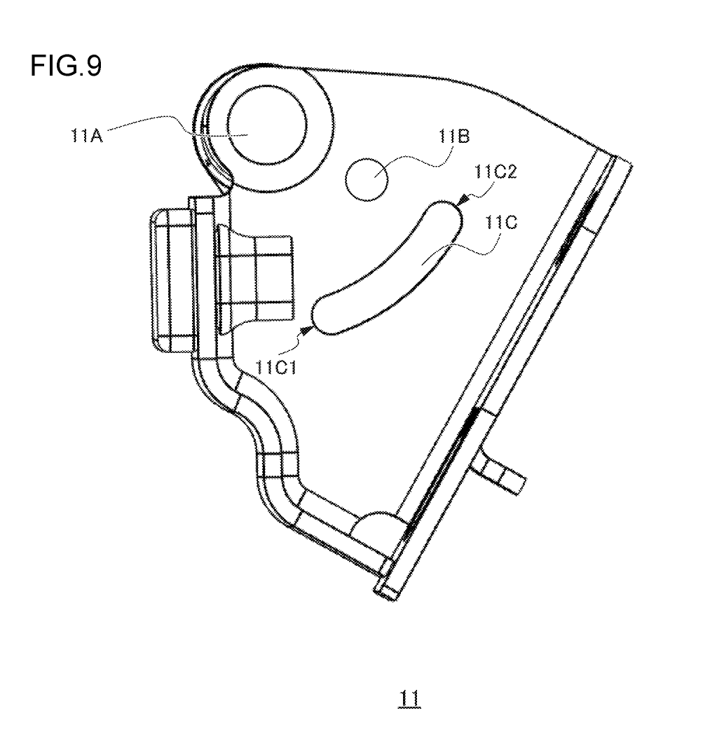

FIG. 9 is a top view illustrating a base 11 of the first embodiment according to this disclosure.

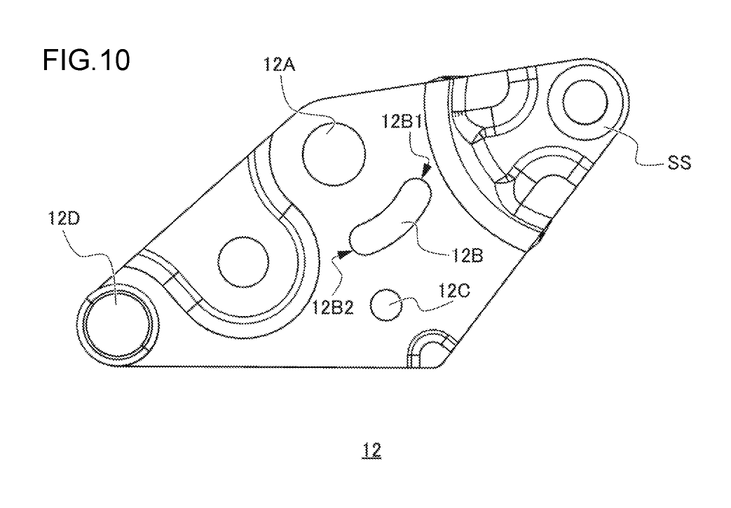

FIG. 10 is a top view illustrating a lever 12 of the first embodiment according to this disclosure.

As illustrated in FIGS. 6, 7, and 8, the striker unit 10 includes the base 11 that is provided on the vehicle body C1 (not illustrated) side, the lever 12 that is rotatably provided on the base 11, and a boss 13 that functions as a rotation axis of the lever 12 and that rotatably mounts the lever 12 on the base 11.

In addition, the striker unit 10 includes a biasing member 14 that is mounted on the base 11 in conjunction with the lever 12 by the boss 13.

Specifically, as illustrated in FIG. 8, the biasing member 14 is a so-called torsion spring that includes a first end 14A, a second end 14B, and a biasing portion 14C that connects the first end 14A and the second end 14B and that biases the first end 14A and the second end 14B in a separating direction.

As illustrated in FIG. 9, the base 11 includes a fixing hole 11A that fixes the boss 13, a first circular-shaped hole 11B that receives the first end 14A of the biasing member 14 (see FIG. 6), and a first circular-arc-shaped hole 11C that is formed at a position farther from the fixing hole 11A than the first circular-shaped hole 11B, that receives the second end 14B of the biasing member 14 (see FIG. 6), and that extends along a rotation trajectory direction of the lever 12 (hereinafter, simply referred to as a rotation trajectory direction).

Since as described above, the first circular-arc-shaped hole 11C is formed along the rotation trajectory direction of the lever 12, the second end 14B can be moved in association with the rotation of the lever 12.

Note that the first circular-shaped hole 11B is provided at a position closer to a first one side end 11C2 on one side of the rotation trajectory of the first circular-arc-shaped hole 11C.

On the other hand, as illustrated in FIG. 10, the lever 12 includes a boss insertion hole 12A into which a shaft portion of the boss 13 is inserted, a second circular-arc-shaped hole 12B that receives the first end 14A of the biasing member 14 and that extends in the rotation trajectory direction of the lever 12 (hereinafter, simply referred to as a rotation trajectory direction), and a second circular-shaped hole 12C that is formed at a position farther from the boss insertion hole 12A than the second circular-arc-shaped hole 12B and that receives the second end 14B of the biasing member 14 (see FIG. 6).

Since as described above, the second circular-arc-shaped hole 12B is formed along the rotation trajectory direction of the lever 12, the first end 14A can be moved in association with the rotation of the lever 12.

Note that the second circular-shaped hole 12C is provided at a position closer to a second other side end 12B2 on the other side of the rotation trajectory of the second circular-arc-shaped hole 12B.

In addition, the lever 12 includes a pressing force receiving portion 12D that is provided on the other side of the boss insertion hole 12A, the second circular-arc-shaped hole 12B, and the second circular-shaped hole 12C and the striker shaft SS that is provided on one side of the boss insertion hole 12A, the second circular-arc-shaped hole 12B, and the second circular-shaped hole 12C.

The pressing force receiving portion 12D is, as can be seen from FIG. 2, a portion that receives a pressing force from the guide portion 23 when the sliding door C2 further slides to the right-hand side of the drawing to be positioned at the full-open position.

When the pressing force receiving portion 12D is pressed by the guide portion 23 and the lever 12 rotates about the boss 13 in such a manner that the pressing force receiving portion 12D comes close to the base 11, the striker shaft SS biases the latch claw portion 24C1 in the direction opposite to the arrow X (see FIGS. 4 and 5).

FIG. 11 is a diagram illustrating the striker shaft SS of the first embodiment according to this disclosure biasing the latch claw portion 24C1 of the latch drive portion 24C in the direction opposite to the arrow X (see FIGS. 4 and 5).

As illustrated in FIG. 11, when the lever 12 rotates (see Y1) about the boss 13 in such a manner that the pressing force receiving portion 12D comes close to the base 11, the striker shaft SS also rotates (see Y2) about the boss 13 in such a manner that the striker shaft SS comes close to the latch claw portion 24C1 and the latch claw portion 24C1 is biased (see Y3) in the direction opposite to the arrow X (see FIGS. 4 and 5) by the striker shaft SS.

As a result, as described afore with reference to FIG. 5, the protrusion 24C21 of the lock portion 24C2 engages with the projecting portion 24C12 of the latch claw portion 24C1, and this state is maintained.

In other words, by the locking device 1, the state in which the sliding door C2 of the vehicle C is locked to maintain the sliding door C2 at the full-open position is established.

On the other hand, the lever 12, which includes the striker shaft SS of the striker unit 10, is provided on the base 11 in a rotatable manner between a first position at the time of releasing locking of the striker shaft SS (see FIG. 6 and a state Z1 in FIG. 11) and a second position at the time of locking of the striker shaft SS (see FIG. 7 and a state Z2 in FIG. 11).

Since the first end 14A of the biasing member 14 is received in the first circular-shaped hole 11B of the base 11, which is provided on the vehicle body C1 (not illustrated) side (the base 11 that is fixed to the vehicle body C1), the first end 14A serves as a fixed end.

Since in the lever 12, as illustrated in FIGS. 6 and 7, the second circular-arc-shaped hole 12B, which corresponds to the first circular-shaped hole 11B in the base 11, is provided, when the lever 12 rotates from the state in FIG. 6 to the state in FIG. 7, the lever 12 can rotate without movement thereof being obstructed by the first end 14A of the biasing member 14, which serves as the fixed end.

Likewise, since in the base 11, the first circular-arc-shaped hole 11C, which corresponds to the second circular-shaped hole 12C in the lever 12, is provided, when the lever 12 rotates from the state in FIG. 6 to the state in FIG. 7, the lever 12 can rotate without movement of the second end 14B of the biasing member 14, which rotates in conjunction with the second circular-shaped hole 12C of the lever 12, being obstructed.

Note that the second end 14B of the biasing member 14 is sometimes referred to as a moving end since the second end 14B rotates in conjunction with the second circular-shaped hole 12C.

Although the biasing portion 14C of the biasing member 14 biases the first end 14A and the second end 14B in such a way as to cause the first end 14A and the second end 14B to move away from each other in the rotation trajectory direction, since, as described above, the first end 14A serves as a fixed end, the biasing member 14 serves as a component biasing the lever 12 toward the first position (see FIG. 6 and the state Z1 in FIG. 11) side.

Therefore, when the engagement between the projecting portion 24C12 of the latch claw portion 24C1 and the protrusion 24C21 of the lock portion 24C2 is released, the lever 12 rotates in such a manner as to bring the state illustrated in FIG. 7 into the state illustrated in FIG. 6.

In a case where when the lever 12 rotates in this way, the lever 12 collides with the base 11, a loud collision sound occurs.

Therefore, in the first embodiment, as illustrated in FIG. 6, the second circular-arc-shaped hole 12B includes a second one side end 12B1 on one side in the rotation trajectory direction with which the first end 14A of the biasing member 14 comes into contact when the lever 12 is positioned at the first position (see FIG. 6 and the state Z1 in FIG. 11), which enables the first position to be set to a position before a position at which the lever 12 collides with the base 11.

In addition, as illustrated in FIG. 6, the first circular-arc-shaped hole 11C includes a first another side end 11C1 on another side in the rotation trajectory direction with which the second end 14B of the biasing member 14 comes into contact when the lever 12 is positioned at the first position (see FIG. 6 and the state Z1 in FIG. 11).

The first circular-arc-shaped hole 11C further including the first another side end 11C1 on the another side in the rotation trajectory direction with which the second end 14B of the biasing member 14 comes into contact when the lever 12 is positioned at the first position (see FIG. 6 and the state Z1 in FIG. 11) as described above enables the lever 12 to more stably stop at the first position before a position at which the lever 12 collides with the base 11.

Although in the configuration as described above, when the lever 12 returns to the first position (see FIG. 6 and the state Z1 in FIG. 11), the second one side end 12B1 of the second circular-arc-shaped hole 12B is to collide with the first end 14A of the biasing member 14, since collision energy is proportional to mass, it is expected that collision energy when the biasing member 14, which has a smaller mass, collides with the base 11 is smaller than collision energy when the lever 12 collides with the base 11, and a collision sound can be suppressed.

In addition, since the first end 14A of the biasing member 14 is a portion that is formed of a material of which the biasing member 14 is formed, it is expected that the first end 14A works elastically to mitigate a collision force when a collision occurs, as a result of which a collision sound can be suppressed.

Further, although when the lever 12 returns to the first position (see FIG. 6 and the state Z1 in FIG. 11), the second end 14B of the biasing member 14 collides with the first another side end 11C1 of the first circular-arc-shaped hole, since this collision causes the collision force to be dispersed and the second end 14B of the biasing member 14 is a portion that is formed of a material of which the biasing member 14 is formed, it is expected that the second end 14B works elastically to mitigate the collision force at the time of collision, as a result of which the collision sound can be further suppressed.

In addition, since when the lever 12 is positioned at the first position (see FIG. 6 and the state Z1 in FIG. 11), the lever 12 is in a state in which movement of the lever 12 is restricted by the first end 14A and the second end 14B of the biasing member 14, the lever 12 can be more stably positioned at the first position than when the movement of the lever 12 is restricted only by the first end 14A of the biasing member 14.

Thus, the lever 12 can be prevented from jolting in association with vibration or the like of the vehicle C.

### Second Embodiment

Next, a locking device 1 of a second embodiment according to this disclosure that locks a sliding door C2 of a vehicle C at a full-open position of the sliding door C2 will be described.

Since the locking device 1 of the second embodiment has the same basic configuration as the locking device 1 of the first embodiment and differs from the locking device 1 of the first embodiment only in some part of configurations of a base 11 and a lever 12, differences from the first embodiment are mainly described in the following description and descriptions of the same points are sometimes omitted.

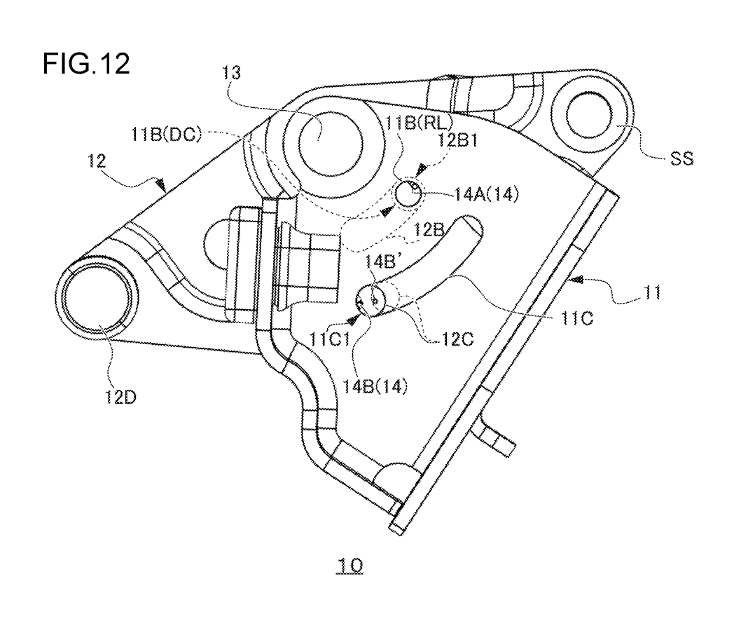

FIG. 12 is a diagram for a description of a problem to be solved by the locking device 1 of the second embodiment according to this disclosure that locks the sliding door C2 of the vehicle C at the full-open position of the sliding door C2 and is a diagram corresponding to FIG. 6.

For example, as illustrated in FIG. 12, when an actually formed first circular-shaped hole 11B (RL) becomes smaller than a design center first circular-shaped hole 11B (DC), a first end 14A of a biasing member 14 does not come into contact with a second one side end 12B1 of a second circular-arc-shaped hole 12B of the lever 12, the lever 12 is positioned only by bias from a second end 14B of the biasing member 14, and the lever 12 becomes more likely to jolt.

Note that although in the above description, an example is described using the first circular-shaped hole 11B, the same applies to other holes, and when the lever 12 is positioned at a first position at which the striker shaft SS is not locked, it is preferable for the first end 14A and the second end 14B of the biasing member 14 to be in contact with both the lever 12 and the base 11 to suppress jolting.

For example, in a case where, as illustrated in FIG. 12, the second end 14B of the biasing member 14 stops at a position indicated by a second end 14B' where the second end 14B has not moved to an original position due to production error in a first circular-arc-shaped hole 11C, since even when there is no production error in the afore-described first end 14A, the lever 12 cannot rotate to a predetermined position, the first end 14A of the biasing member 14 does not come into contact with the second one side end 12B1 of the second circular-arc-shaped hole 12B of the lever 12, the lever 12 is positioned only by the bias from the second end 14B of the biasing member 14, and the lever 12 becomes likely to jolt.

Therefore, as the second embodiment, a method for preventing the lever 12 from becoming likely to jolt due to production variation as described above will be described below.

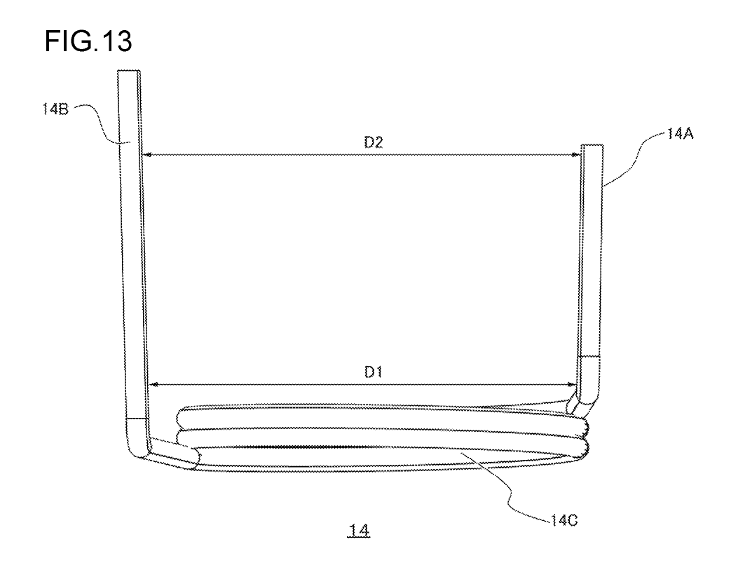

FIG. 13 is a diagram illustrating a torsion spring that is a biasing member 14 described in the first embodiment according to this disclosure.

As illustrated in FIG. 13, not only does the torsion spring, which serves as the biasing member 14, have a tendency that distance between the first end 14A and the second end 14B expands from D1 to D2 as separating away from a biasing portion 14C, but also the torsion spring can be easily produced even if the torsion spring is actively produced.

When the first end 14A and the second end 14B spread toward the ends as separating away from the biasing portion 14C as described above, a member located away from the biasing portion 14C can easily come into contact with the first end 14A and the second end 14B compared with a member located closer to the biasing portion 14C even when an edge of the member is positioned on the outer side of the first end 14A and the second end 14B in the biasing direction, due to the shape of the first end 14A and the second end 14B spreading toward the end.

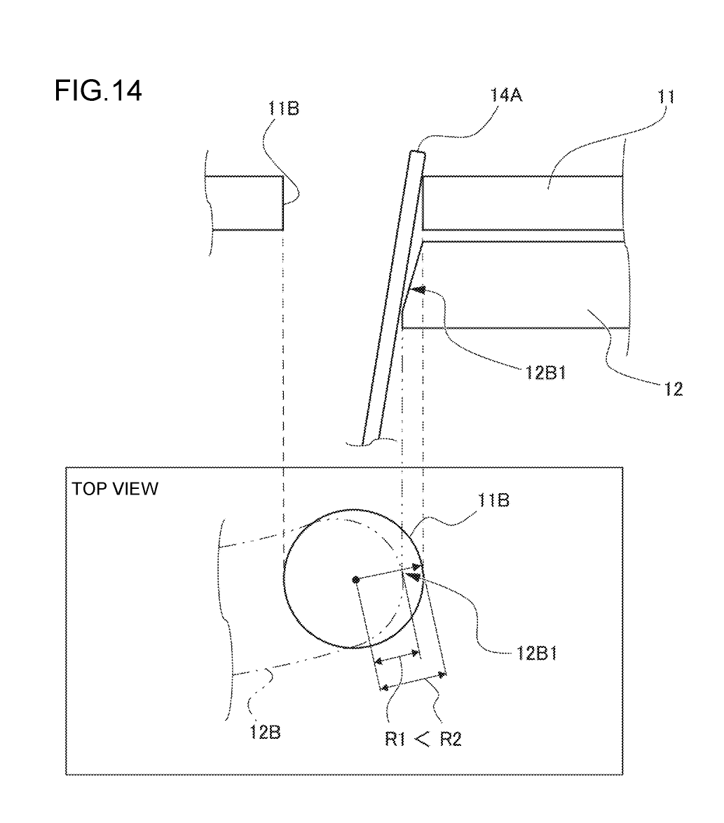

FIG. 14 is an enlarged view of a vicinity of the first end 14A when the lever 12 is positioned at the first position of the locking device 1 of the second embodiment according to this disclosure, which locks the sliding door C2 of the vehicle C at the full-open position of the sliding door C2.

Note that in FIG. 14, a cross-sectional view is illustrated on the upper side, and a top view illustrating the first circular-shaped hole 11B and the second circular-arc-shaped hole 12B in such a manner that the positions of the first circular-shaped hole 11B and the second circular-arc-shaped hole 12B in the cross sections can be easily recognized is illustrated within a rectangular frame on the lower side.

In the second embodiment, as with the first embodiment, the biasing portion 14C of the biasing member 14 is also positioned on the lever 12 side.

In this case, since a portion on the base 11 side of the first end 14A of the biasing member 14 further spreads toward the outer side in the biasing direction than a portion on the lever 12 side, it is preferable that the first circular-shaped hole 11B be formed in a hole with a radius R2 larger than R (see radius of curvature R1) of an end shape of the second one side end 12B1 of the second circular-arc-shaped hole 12B and, in consideration of manufacturing error, the first circular-shaped hole 11B be made larger, as illustrated in FIG. 14.

For example, the radius R2 of the first circular-shaped hole 11B is preferably set larger than the radius of curvature R1 of the R of the end shape of the second one side end 12B1 of the second circular-arc-shaped hole 12B within a range of 0.4 mm or less.

In addition, in order to actively use the shape of the first end 14A spreading toward the end, it is preferable that the second circular-arc-shaped hole 12B have a surface on the base 11 side chamfered, as illustrated in FIG. 14.

Note that since when the biasing portion 14C of the biasing member 14 is positioned on the base 11 side, a relationship of the first end 14A and the second end 14B spreading toward the end is reversed, it is only necessary to replace a relationship between structures of the above-described first circular-shaped hole 11B and second circular-arc-shaped hole 12B.

In other words, in a case where the biasing portion 14C of the biasing member 14 is positioned on the base 11 side, it is only necessary that the R of the end shape of the second one side end 12B1 of the second circular-arc-shaped hole 12B is larger than the radius of the first circular-shaped hole 11B and a surface on the lever 12 side of the first circular-shaped hole 11B is chamfered.

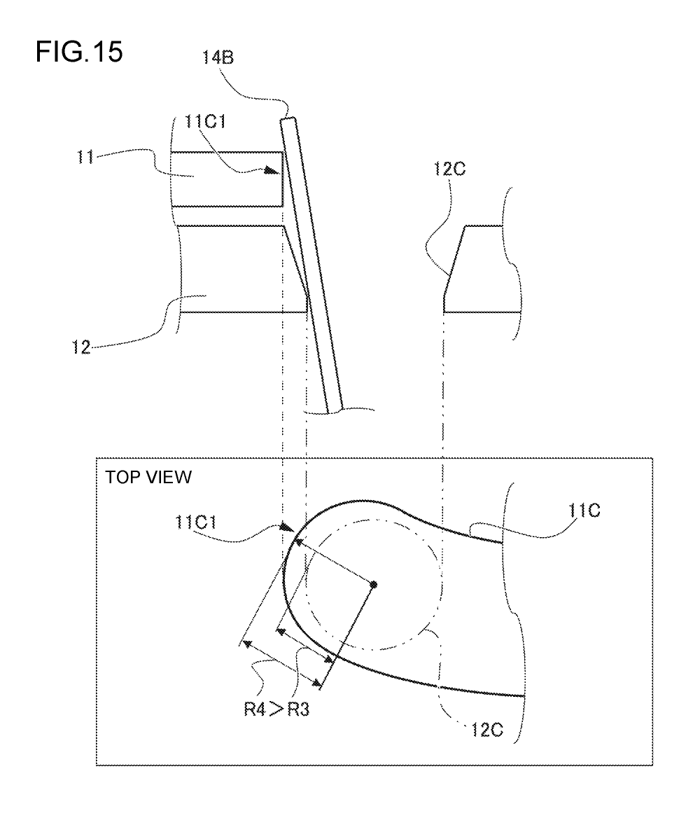

FIG. 15 is an enlarged view of a vicinity of the second end 14B when the lever 12 is positioned at the first position of the locking device 1 of the second embodiment according to this disclosure, which locks the sliding door C2 of the vehicle C at the full-open position of the sliding door C2.

Since, as with the first end 14A, a portion on the base 11 side of the second end 14B of the biasing member 14 also further spreads toward the outer side in the biasing direction than a portion on the lever 12 side, it is preferable to make R (see radius of curvature R4) of an end shape of a first another side end 11C1 of the first circular-arc-shaped hole 11C larger than a radius R3 of a second circular-shaped hole 12C and to make, in consideration of manufacturing error, the first another side end 11C1 of the first circular-arc-shaped hole 11C larger, as illustrated in FIG. 15.

For example, the radius of curvature R4 of the R of the end shape of the first another side end 11C1 of the first circular-arc-shaped hole 11C is preferably set larger than the radius R3 of the second circular-shaped hole 12C within a range of 0.4 mm or less.

In addition, in order to actively use the shape of the second end 14B spreading toward the end, it is preferable that the second circular-shaped hole 12C have a surface on the base 11 side chamfered, as illustrated in FIG. 15.

Meanwhile, although only the first another side end 11C1 of the first circular-arc-shaped hole 11C may be made larger, it can be said that manufacturing is easier when the entire first circular-arc-shaped hole 11C is formed larger.

Therefore, it is preferable to form the first circular-arc-shaped hole 11C as a hole with a width double the radius of curvature R4 of the R of the end shape of the first another side end 11C1.

In other words, the first circular-arc-shaped hole 11C is preferably formed in a circular-arc-shaped hole where circles of a radius R4 are strung in a continuous manner along the rotation trajectory direction of the lever 12.

Note that the same applies to the second circular-arc-shaped hole 12B in the afore-described case where the biasing portion 14C of the biasing member 14 is positioned on the base 11 side, and it is preferable to form the second circular-arc-shaped hole 12B as a hole with a width double the radius of curvature of the R of the end shape of the second one side end 12B1.

On the other hand, since when the biasing portion 14C of the biasing member 14 is positioned on the base 11 side, a relationship of the first end 14A and the second end 14B spreading toward the end is reversed, it is only necessary to replace the above-described relationship between structures of the first circular-arc-shaped hole 11C and second circular-shaped hole 12C.

In other words, it is only necessary that the second circular-shaped hole 12C has a radius greater than the R of the end shape of the first another side end 11C1 of the first circular-arc-shaped hole 11C and the first circular-arc-shaped hole 11C has a surface on the lever 12 side chamfered.

According to the configuration of the second embodiment as described above, since as described afore, in consideration of manufacturing error, the first end 14A and the second end 14B of the biasing member 14 can be brought into contact with both the lever 12 and the base 11, jolting of the lever 12 when the lever 12 is positioned at the first position can be suppressed.

A locking device is a device that locks a sliding door of a vehicle at a full-open position of the sliding door,

the locking device includes:

a striker unit that is provided on a vehicle body side of the vehicle and includes a striker shaft; and

a latch mechanism that is provided on the sliding door side and locks the striker shaft at the full-open position,

the striker unit includes:

a base that is provided on a vehicle body side;

a lever that includes the striker shaft and is provided on the base in a rotatable manner between a first position at a time of releasing locking of the striker shaft and a second position at a time of locking of the striker shaft; and

a biasing member that biases the lever toward the first position side,

the biasing member includes:

a first end;

a second end; and

a biasing portion that connects the first end and the second end,

the base includes:

a first circular-shaped hole that receives the first end; and

a first circular-arc-shaped hole that receives the second end and in which the second end is movable in association with rotation of the lever,

the lever includes:

a second circular-arc-shaped hole that receives the first end and in which the first end is movable in association with rotation of the lever; and

a second circular-shaped hole that receives the second end, and

the second circular-arc-shaped hole includes a second one side end with which the first end comes into contact when the lever is positioned at the first position.

According to this disclosure, a locking device that locks a sliding door suppressing a collision sound when a rotatable lever having a striker shaft returns to a position before locking, without providing cushioning material or the like is provided.

In the above-described locking device, the first circular-arc-shaped hole may include a first another side end with which the second end comes into contact when the lever is positioned at the first position.

In the above-described locking device,

the biasing portion may be positioned on the lever side,

the first circular-shaped hole may have a radius being larger than R of an end shape of the second one side end of the second circular-arc-shaped hole,

the first circular-arc-shaped hole may have R of an end shape of the first another side end being larger than a radius of the second circular-shaped hole, and

the second circular-shaped hole and the second circular-arc-shaped hole may have surfaces on the base side being chamfered.

In the above-described locking device,

the biasing portion may be positioned on the base side,

the second circular-shaped hole may have a radius being larger than R of an end shape of the first another side end of the first circular-arc-shaped hole,

the second circular-arc-shaped hole may have R of an end shape of the second one side end being larger than a radius of the first circular-shaped hole, and

the first circular-shaped hole and the first circular-arc-shaped hole may have surfaces on the base side being chamfered.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A locking device that locks a sliding door of a vehicle at a full-open position of the sliding door, wherein
the locking device includes:
a striker unit that is provided on a vehicle body side of the vehicle and includes a striker shaft; and
a latch mechanism that is provided on the sliding door side and locks the striker shaft at the full-open position,
the striker unit includes:
a base that is provided on a vehicle body side;
a lever that includes the striker shaft and is provided on the base in a rotatable manner between a first position at a time of releasing locking of the striker shaft and a second position at a time of locking of the striker shaft; and
a biasing member that biases the lever toward the first position side,
the biasing member includes:
a first end;
a second end; and
a biasing portion that connects the first end and the second end,
the base includes:
a first circular-shaped hole that receives the first end; and
a first circular-arc-shaped hole that receives the second end and in which the second end is movable in association with rotation of the lever,
the lever includes:
a second circular-arc-shaped hole that receives the first end and in which the first end is movable in association with rotation of the lever; and
a second circular-shaped hole that receives the second end, and
the second circular-arc-shaped hole includes a second one side end with which the first end comes into contact when the lever is positioned at the first position.

2. The locking device according to claim 1, wherein the first circular-arc-shaped hole includes a first another side end with which the second end comes into contact when the lever is positioned at the first position.

3. The locking device according to claim 2, wherein
the biasing portion is positioned on the lever side,
the first circular-shaped hole has a radius being larger than R of an end shape of the second one side end of the second circular-arc-shaped hole,
the first circular-arc-shaped hole has R of an end shape of the first another side end being larger than a radius of the second circular-shaped hole, and
the second circular-shaped hole and the second circular-arc-shaped hole have surfaces on the base side being chamfered.

4. The locking device according to claim 2, wherein
the biasing portion is positioned on the base side,
the second circular-shaped hole has a radius being larger than R of an end shape of the first another side end of the first circular-arc-shaped hole,
the second circular-arc-shaped hole has R of an end shape of the second one side end being larger than a radius of the first circular-shaped hole, and
the first circular-shaped hole and the first circular-arc-shaped hole have surfaces on the lever side being chamfered.
